(19) United States
(12) Patent Application Publication
(10) Pub. No.: US 2016/0117647 A1
(43) Pub. Date: Apr. 28, 2016

(54) MANAGING MONEY MOVEMENT METHODS INVOLVING A PAYMENT SERVICE SYSTEM

(71) Applicants: Amit Dhingra, Mountain View, CA (US); Billy Yuen, Mountain View, CA (US)

(72) Inventors: Amit Dhingra, Mountain View, CA (US); Billy Yuen, Mountain View, CA (US)

(73) Assignee: Intuit Inc., Mountain View, CA (US)

(21) Appl. No.: 14/526,327

(22) Filed: Oct. 28, 2014

(51) Int. Cl. G06Q 20/02; G06Q 20/10

(52) U.S. Cl. CPC G06Q 20/027; G06Q 20/10

(57) ABSTRACT

A method to send a payment to satisfy an obligation. The method includes receiving, by a payment service, a target time request to complete the payment, wherein the target time request comprises a first target time for completing at least a first portion of the payment, comparing, in response to receiving the target time request, a current time and the first target time to determine a first available payment processing time, selecting a first electronic funds transfer (EFT) network from a plurality of EFT networks based on matching the first available payment processing time to a first estimated payment processing time of the first EFT network, and initiating, in response to selecting the first EFT network, processing of the first portion of the payment using the first EFT network.

### BACKGROUND

An electronic funds transfer (EFT) refers to the computer-based systems used to perform financial transactions electronically. For example, the Automated Clearing House Network (ACH) is a secure payment transfer system that connects U.S. fmancial institutions. The ACH network acts as the central clearing facility for EFT transactions that occur nationwide. A majority of ACH transactions (if successful) settle by next banking day. In another example, a debit card network is an inter-bank network to credit or debit a debit card holder's account. Crediting the debit card holder's account (also referred to as account to account (A2A) transfers) using the debit card network can often be completed within minutes. In yet another example, book transfers (also referred to as intra-bank transfers) are the transfer of funds from one deposit account to another at the same financial institution. Book transfers are often completed within same banking day.

### SUMMARY

In general, in one aspect, the invention relates to a method to send a payment to satisfy an obligation. The method includes receiving, by a payment service, a target time request to complete the payment, wherein the target time request comprises a first target time for completing at least a first portion of the payment, comparing, in response to receiving the target time request, a current time and the first target time to determine a first available payment processing time, selecting a first electronic funds transfer (EFT) network from a plurality of EFT networks based on matching the first available payment processing time to a first estimated payment processing time of the first EFT network, and initiating, in response to selecting the first EFT network, processing of the first portion of the payment using the first EFT network.

In general, in one aspect, the invention relates to a system for sending a payment to satisfy an obligation. The system includes a processor of a computer server operated by a payment service, memory storing instructions when executed causing the processor to receive a target time request to complete the payment, wherein the target time request comprises a first target time for completing at least a first portion of the payment, compare, in response to the target time request, a current time and the first target time to determine a first available payment processing time, select a first electronic funds transfer (EFT) network from a plurality of EFT networks, wherein the first EFT network is selected based on matching the first available payment processing time to a first estimated payment processing time of the first EFT network, and initiate, in response to selecting the first EFT network, processing of the first portion using the first EFT network, and a repository coupled to the processor and configured to store the first estimated payment processing time.

In general, in one aspect, the invention relates to a non-transitory computer readable medium storing instructions to send a payment to satisfy an obligation. The instructions includes functionality to receive, by a payment service, a target time request to complete the payment, wherein the target time request comprises a first target time for completing at least a first portion of the payment, compare, in response to receiving the target time request, a current time and the first target time to deteunine a first available payment processing time, select a first electronic funds transfer (EFT) network from a plurality of EFT networks based on matching the first available payment processing time to a first estimated payment processing time of the first EFT network, and initiate, in response to selecting the first EFT network, processing of the first portion of the payment using the first EFT network.

Other aspects of the invention will be apparent from the following detailed description and the appended claims.

### BRIEF DESCRIPTION OF DRAWINGS

FIG. 1 shows a schematic diagram of a system of managing money movement methods in accordance with one or more embodiments of the invention.

FIG. 2 shows a flowchart of a method of managing money movement methods in accordance with one or more embodiments of the invention.

FIGS. 3A-3B show examples of managing money movement methods in accordance with one or more embodiments of the invention.

FIG. 4 shows a diagram of a computer system in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

Embodiments of the invention provide a system and method for selecting most cost effective mechanism to move funds based on the timeliness criteria. In one or more embodiments of the invention, a payment service selects, based on a payer's or payee's target time request to complete the payment, one of several available electronic funds transfer (EFT) networks to initiate processing of the payment.

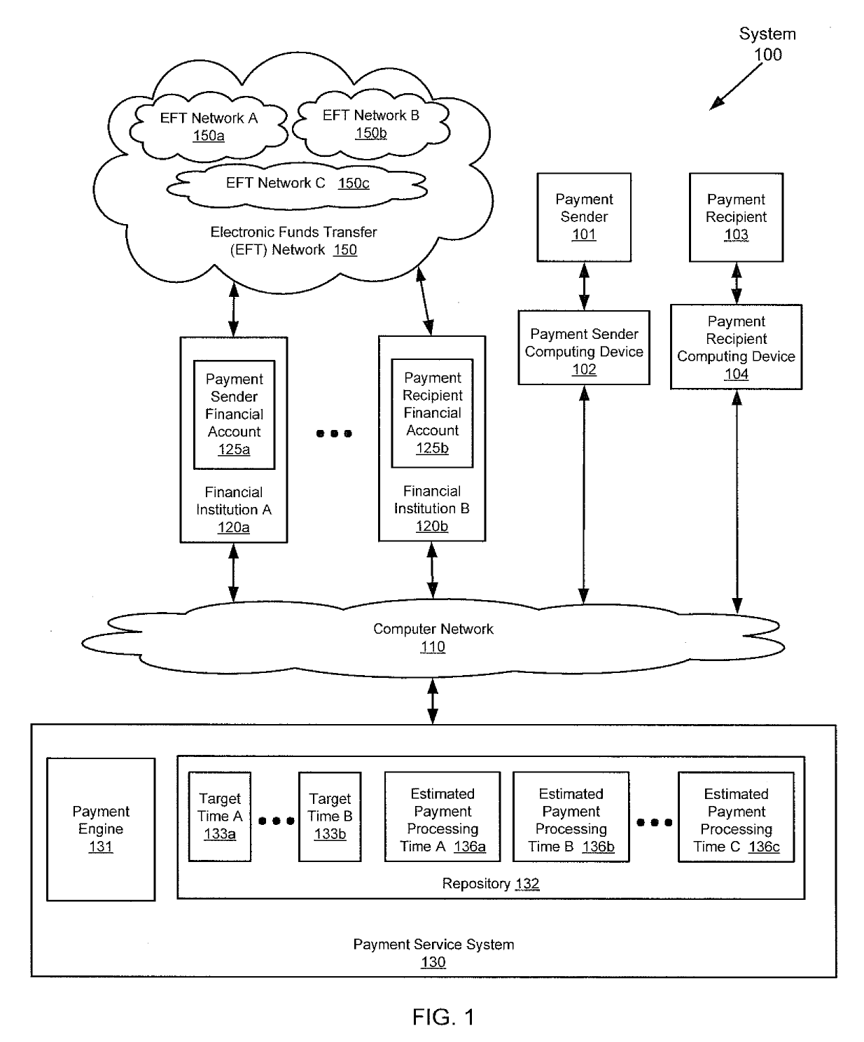

FIG. 1 depicts a schematic block diagram of a system (100) in accordance with one or more embodiments of the invention. In one or more embodiments of the invention, one or more of the modules and elements shown in FIG. 1 may be omitted, repeated, and/or substituted. Accordingly, embodiments of the invention should not be considered limited to the specific arrangements of modules shown in FIG. 1.

As shown in FIG. 1, the system (100) includes a payment sender (101) having a payment sender computing device (102), a payment recipient (103) having a payment recipient computing device (104), a financial institution A (120a), a financial institution B (120b), and a payment service system (130) having a payment engine (131) and a repository (132) storing information used by the payment engine (131). In addition, a payment sender financial account (125a) is held at the financial institution A (120a) for the payment sender (101). A payment recipient financial account (125b) is held at the financial institution B (120b) for the payment recipient (103). In one or more embodiments of the invention, a payment application (not shown) provided by the payment service system (130) is installed on the payment sender computing device (102) and/or the payment recipient computing device (104).

Further as shown in FIG. 1, the payment sender (101), payment recipient (103), financial institution A (120a), financial institution B (12ba), and payment service system (130) are coupled via a computer network (110). For example, the computer network (110) may include a wireless communication network (e.g., a mobile phone network) and wired and/or wireless portions of public and/or private data network, such as wide area networks (WANs), local area networks (LANs), Internet, etc. Further, the financial institution A (120a) and financial institution B (12ba) are coupled via electronic funds transfer (EFT) networks (150), such as the EFT network A (150a), EFT network B (150b), and EFT network C (150c). In one or more embodiments, a financial institution is an institution that provides financial services for its clients or members. For example, the financial institution A (120a) and financial institution B (12ba) may be a bank, a credit union, a investment brokerage firm, a mortgage lending company, a trust company, an insurance company, a pension funds company, etc. In one or more embodiments, each EFT network is a secured network for conducting the EFT activities.

In particular, each EFT network is a network configured to facilitate communication between the financial institution A (120a) and financial institution B (12ba) for processing EFTs. For example, the EFT network A (150a) may be the ACH network, the EFT network B (150b) may be the debit card network, and the EFT network C (150c) may be a book transfer network, which is a proprietary inter-bank payment network implemented by the payment service system (130) using book transfers at financial institutions. For example, sending the payment using the book transfer network (e.g., EFT network C (150c)) may be accomplished by two contemporaneous book transfers of (i) transferring the payment amount from the payment sender financial account (125a) to an account held at the financial institution A (120a) on behalf of the payment service system (130), and (ii) transferring the payment amount from an account held at the financial institution B (120b) on behalf of the payment service system (130) to the payment recipient financial account (125b).

In one or more embodiments, the payment sender (101) is the account holder of the payment sender financial account (125a), who may be an individual or a business entity sending a payment from the payment sender financial account (125a) to the payment recipient (103). Similarly, the payment recipient (103) is the account holder of the payment recipient financial account (125b), who may be an individual or a business entity receiving a payment to the payment recipient financial account (125b) from the payment sender (101). In particular, the payment is to fulfill an obligation of the payment sender (101) to the payment recipient (103). The obligation may be based on a purchase transaction, or a debt between the payment sender (101) and the payment recipient (103). In one or more embodiments, the payment sender financial account (125a) and payment recipient financial account (125b) may include a checking account, a debit card account, a savings account, a retirement account, or other types of financial accounts. For example, the financial institution A (120a) may provide an electronic check service and/or a debit card to the payment sender (101) in association with the payment sender financial account (125a). Similarly, the financial institution B (120b) may provide an electronic check service and/or a debit card to the payment recipient (103) in association with the payment recipient financial account (125b). In one or more embodiments, the financial institution A (120a) and financial institution B (120b) may be the same entity.

In one or more embodiments, the payment sender computing device (102) and payment recipient computing device (104) may be any electronic device configured with computing and communication capabilities. For example, the payment sender computing device (102) and payment recipient computing device (104) may include a smartphone, a tablet computer, a notebook computer, a desktop computer, etc. In one or more embodiments, the payment sender computing device (102) and payment recipient computing device (104) are installed with the payment application to send and receive payments using the payment service system (130). In one or more embodiments, the payment application allows the payment sender (101) to initiate a payment to the payment recipient (103). Further, the payment application may also allow the payment recipient (103) to request a payment from the payment sender (101). In one or more embodiments, the payment application allows the payment sender (101) or the payment recipient (103) to specify a target time when the payment is to be completed. For example, the target time may be specified in a user interface menu used by the payment sender (101) to initiate the payment. Similarly, the target time may be specified in a user interface menu used by the payment recipient (103) to request the payment. In another example, the target time may be specified in a user interface menu used by the payment sender (101) to display a payment notification notifying the payment sender (101) that the payment is requested by the payment recipient (103). Similarly, the target time may be specified in a user interface menu used by the payment recipient (103) to display a payment notification notifying the payment recipient (103) that the payment is initiated by the payment sender (101).

In one or more embodiments, the payment service system (130) includes the payment engine (131) corresponding to a software and/or hardware component that is configured to carry out the EFT based payment initiated by the payment sender computing device (102) or payment recipient computing device (104). In one or more embodiments, the payment engine (131) selects, based on a request to complete the payment by a target time, one of several available EFT networks (e.g., EFT network A (150a), EFT network B (150b), EFT network C (150c)) to initiate processing of the payment. Specifically, the target time is a future time point when the payment is targeted to be completed.

In one or more embodiments, the target time is specified by either the payment sender (101) or the payment recipient (103) using their respective computing devices. In one or more embodiments, the payment is initiated by a payment request that includes an amount of the payment, an identifier of the payment sender (101), an identifier of the payment recipient (103), and the target time. For example, the payment request may be specified by the payment sender (101) or the payment recipient (103) using their respective computing devices. In one or more embodiments, the target time is specified separately from the payment request. For example, the target time may be specified by the payment sender (101) or the payment recipient (103) using their respective computing devices.

In one or more embodiments, the target time is stored in the repository (132) as the intermediate data for use by the payment engine (131). For example, the target time A (133a) may be specified as “October 1, 2014”. In another example, the target time B (133b) may be specified as “two days from now”. In yet another example, another target time may be specified as “within an hour”.

In one or more embodiments, the payment engine (131) selects the EFT networks (e.g., EFT network A (150a), EFT network 13 (150b), EFT network C (150c)) to process the payment further based on an estimated payment processing time associated with each EFT network. Specifically, the estimated payment processing time includes a time period from requesting the selected EFT network to process the payment to an estimated future time point when the payment is expected to be completed using the selected EFT network.

In particular, the payment is completed when the payment recipient (103) is able to withdraw, transfer, or otherwise access funds of the payment in the payment recipient financial account (125b). In one or more embodiments, the estimated payment processing time is stored in the repository (132) for use by the payment engine (131). For example, the estimated payment processing time A (136a) of the ACH network may be one day. In another example, the estimated payment processing time B (136b) of the book transfer network may be less than one day. In yet another example, the estimated payment processing time C (136c) of the debit card network may be 20 minutes. In one or more embodiments, each EFT network charges a service fee for transferring funds. Typically, the EFT network with shorter estimated payment processing time charges a higher fee than the other EFT network with longer estimated payment processing time.

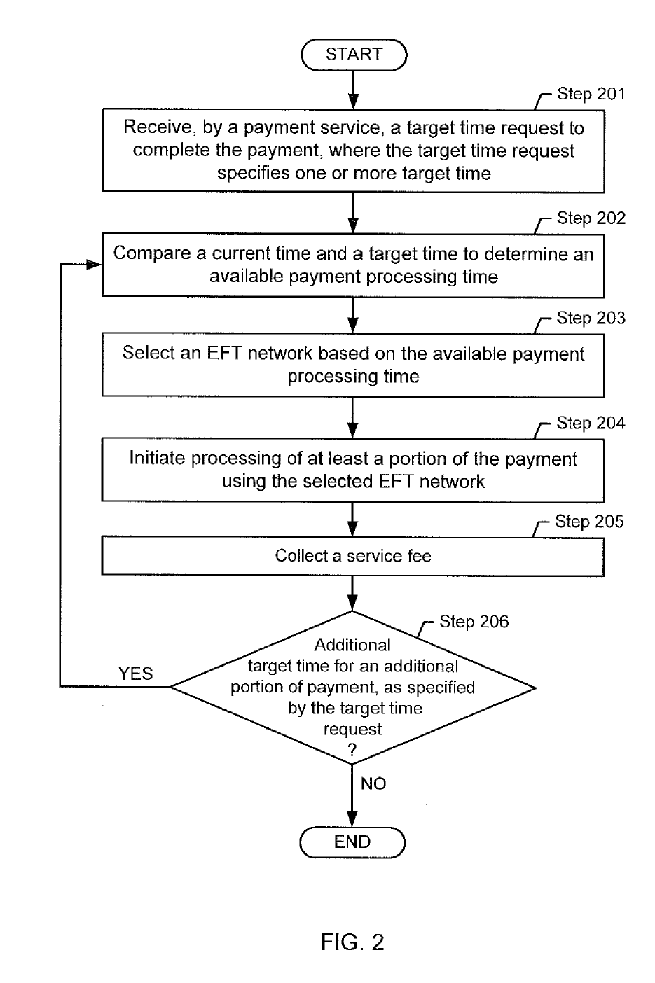

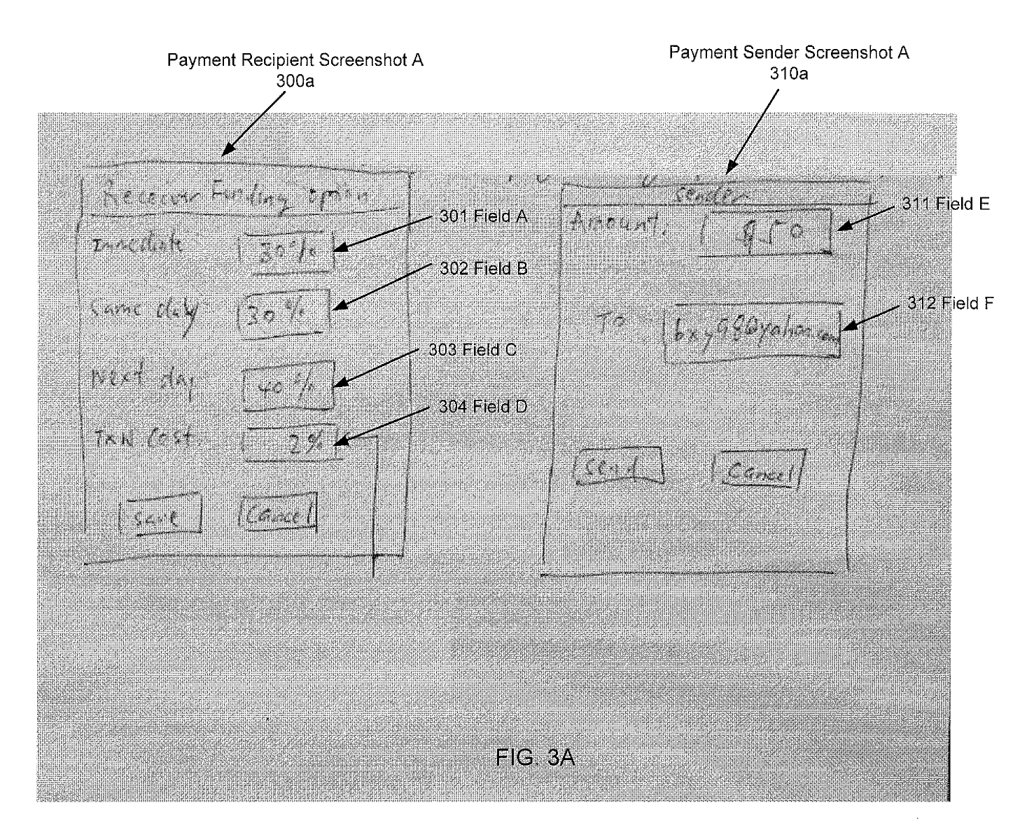

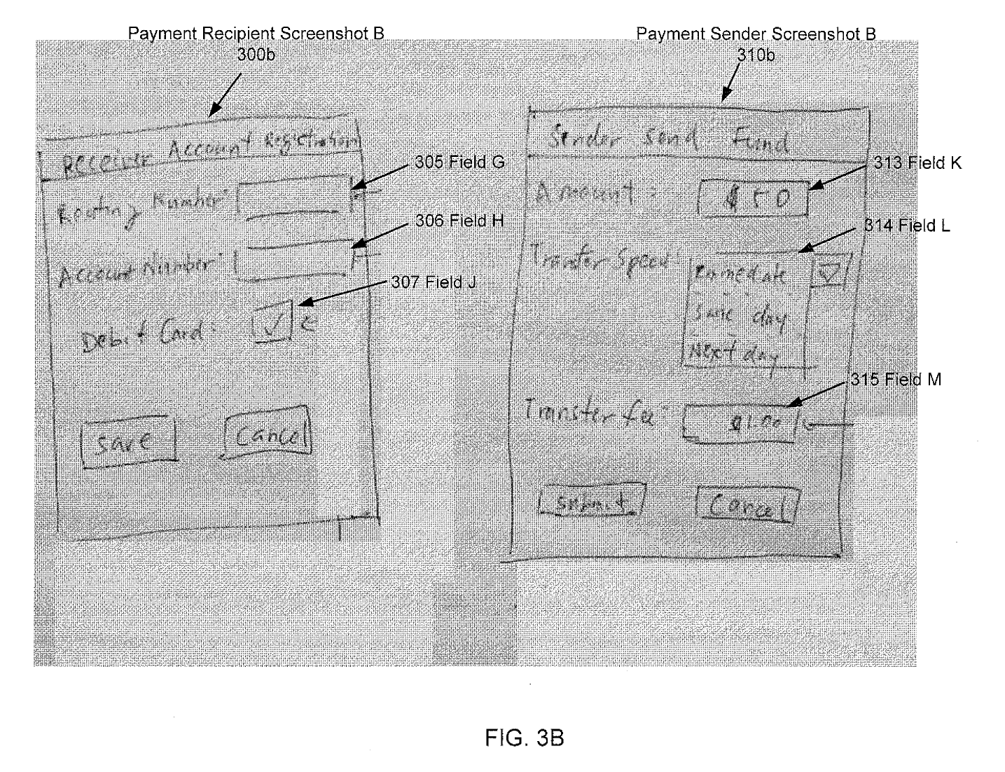

In one or more embodiments, the payment engine (131) selects the EFT network using the method described in reference to FIG. 2 below. An example of the payment sender computing device (102) or payment recipient computing device (104) initiating the payment and specifying the target time is described in reference to FIGS. 3A and 3B below.

FIG. 2 depicts a flowchart of a method in accordance with one or more embodiments of the invention. In one or more embodiments of the invention, one or more of the steps shown in FIG. 2 may be omitted, repeated, and/or performed in a different order. Accordingly, embodiments of the invention should not be considered limited to the specific arrangements of steps shown in FIG. 2. In one or more embodiments, the method described in reference to FIG. 2 may be practiced using the system (100), described in reference to FIG. 1 above.

Initially in Step 201, a target time request to complete the payment is received by a payment service. In one or more embodiments, the target time request includes multiple target times for completing corresponding portions of the payment. In one or more embodiments, the target time request is included in a payment request to initiate the payment. In one or more embodiments, the target time request is specified separately from the payment request. For example, the payment request and the target time specification may be submitted separately, or in combination, to the payment service by a sender of the payment (i.e., payment sender) or a recipient of the payment (i.e., payment recipient). In particular, the payment request and the target time specification may be submitted by different parties (i.e., payment sender or recipient) of the payment.

In Step 202, in response to receiving the target time request, the target time is compared to a current time to detennine an available payment processing time. In other words, the available payment processing time corresponds to the time period starting from the time of receiving the target time request to the future time point defined by the target time. For example, the available payment processing time may be a week, a day, or an hour. In one or more embodiments, multiple available payment processing times are determined for different portions of the payment, corresponding to multiple target times specified in the target time request.

In Step 203, an EFT network is selected from a number of EFT networks based on matching the available payment processing time to an estimated payment processing time of the selected EFT network. In particular, the estimated payment processing time of the selected EFT network is required to be less than the available payment processing time. In this manner, using the selected EFT network ensures that the payment can be completed no later than the target time. In one or more embodiments, multiple EFT networks may satisfy the requirement of the estimated payment processing time being less than the available payment processing time. In such embodiments, one of such multiple EFT networks is selected that has the lowest service fee.

In Step 204, processing of at least a portion of the payment is initiated using the selected EFT network. In one or more embodiments, the payment service initiates EFT activities of the EFT network based on information specified in the payment request received from the payment sender or the payment recipient. For example, a payment sender financial account held at the payment sender's financial institution is identified by the payment service, based on the identifier of the payment sender specified in the payment request.

In one or more embodiments, the payment sender financial account is selected from multiple payment sender financial accounts of the payment sender based on the selected EFT network. For example, the payment sender's checking account is selected if the ACH network is the selected EFT network. In another example, the payment sender's debit card account is selected if the debit card network is the selected EFT network. Similarly, a payment recipient financial account held at the payment recipient's financial institution is identified by the payment service, based on the identifier of the payment recipient specified in the payment request. In one or more embodiments, the payment recipient financial account is selected from multiple payment recipient financial accounts of the payment recipient based on the selected EFT network. For example, the payment recipient's checking account is selected if the ACH network is the selected EFT network. In another example, the payment recipient's debit card account is selected if the debit card network is the selected EFT network.

In Step 205, a service fee is collected. In one or more embodiments, the payment service determines whether the target time is specified by the payment sender or the payment recipient. If the payment service determines that the target time is specified by a sender of the payment, the service fee is debited from the selected payment sender financial account from which the payment is made. If the payment service determines that the target time is specified by a recipient of the payment, the service fee is deducted from the payment amount before the payment amount is credited to the payment recipient financial account. In one or more embodiments, the service fee includes a portion charged by the EFT network and another portion charged by the payment service.

In particular, the service fee charged by the EFT network may depend on the estimated payment processing time of the EFT network. For example, because the estimated payment processing time of the debit card network is more expedient than that of the ACH network, the service fee charged by the debit card network is typically higher than the service fee charged by the ACH network.

In Step 206, a determination is made as to whether there is any additional target time for an additional portion of the payment, as specified in the target time request. If the determination is positive, i.e., there is an additional target time for an additional portion of the payment, the method returns to Step 202 to initiate the additional portion of the payment using another selected EFT network. If the determination is negative, i.e., there is no more target time for any additional portion of the payment, the method ends. In the case where multiple target times are specified by the payment recipient for corresponding portions of the payment, the method iterates through the Steps 202 through 206 one or more times. As a result, an applicable service fee is deducted from each corresponding portion of the payment.

FIGS. 3A-3B show application examples in accordance with one or more embodiments of the invention. While not limited to such, the examples may be practiced using the system (100) of FIG. 1 and based on the method described with respect to FIG. 2 above.

The example depicted in FIG. 3A is related to a scenario of the payment recipient specifying the target time. In this example, the payment recipient receives a payment notification and specifies the target time using the same user interface that is used to display the payment notification.

FIG. 3A shows a payment sender screenshot A (310a) displayed on the payment sender computing device, and a payment recipient screenshot A (300a) displayed on the payment recipient computing device in response to the payment sender initiating the payment. In particular, the payment sender screenshot A (310a) includes the field E (311) where the payment sender has specified the payment amount of $50, and field F (312) where the payment sender has specified the email address of the payment recipient. In addition, the payment sender screenshot A (310a) includes action buttons, such as “send” and “cancel” for sending or cancelling the payment.

Further as shown in FIG. 3A, the payment recipient screenshot A (300a) is part of a payment notification from the payment service to the payment recipient. The payment notification includes the receiver funding option allowing the payment recipient to specify the target time for one or more portion of the payment. The payment recipient screenshot A (300a) includes the field A (301), field B (302), and filed C (303) where the payment recipient has specified that 30% of the payment is to be transferred immediately, another 30% of the payment is to be transferred on the same day, and the remaining 40% of the payment is to be transferred no later than the next day.

Based on the information provided by the payment sender and payment receiver above, the payment service uses the debit card network to transfer 30% of the payment (i.e., $15), uses the book transfer network to transfer another 30% of the payment (i.e., $15), and uses the ACH network to transfer the remaining 40% of the payment (i.e., $20). By adding the fees charged by these EFT networks and a pre-determined fee schedule of the payment service, the total service fee for the payment is calculated by the payment service to be 2% of the payment (i.e., $1), which is displayed in the field D (304) to the payment recipient. As a result, $1 will be deducted from the total payment amount received by the payment recipient. In addition, the payment recipient screenshot A (300a) includes action buttons, such as “save” and “cancel” for saving or cancelling the target time specified in the receiver funding option.

The example depicted in FIG. 3B is related to a scenario of the payment sender specifying the target time. In this example, the payment sender specifies the target time using the same user interface that is used to initiate the payment.

FIG. 3B shows a payment sender screenshot B (310b) displayed on the payment sender computing device, and a payment recipient screenshot B (300b) displayed on the payment recipient computing device in response to the payment sender initiating the payment. In particular, the payment sender screenshot B (310b) includes the field K (313), where the payment sender has specified the payment amount of $50 and field L (314), where the payment sender has specified the target time. Based on the specified target time, the payment service has selected an EFT network and calculated the service fee of $1, which is displayed in the field M (315) to the payment sender. As a result, $1 will be debited from the payment sender's account. In addition, the payment sender screenshot A (310a) includes action buttons, such as “send” and “cancel” for sending or cancelling the payment.

Further as shown in FIG. 3B, the payment recipient screenshot B (300b) is part of a payment notification from the payment service to the payment recipient. The payment notification includes the receiver account registration option allowing the payment recipient to specify one or more payment recipient financial accounts. As shown in FIG. 3B, the payment recipient screenshot B (300b) includes the field G (305), field H (306), and field J (307) where the payment recipient may specify the payment recipient financial account routing number, payment recipient financial account number, and any debit card associated with the payment recipient financial account, respectively. In particular, the payment recipient financial account routing number and the payment recipient financial account number may be used to transfer funds using the ACH network and/or book transfer network. In case the payment service selects the debit card network to transfer funds and determines that no debit card is associated with the payment recipient financial account, the field J (307) is used as an invitation to issue a debit card to the payment recipient. For example, the payment recipient may use the field J (307) to accept the invitation, and accordingly, the payment funds of $50 will be credited to the newly issued debit card to the payment recipient. In addition, the payment recipient screenshot A (300a) includes action buttons, such as “save” and “cancel” for saving or cancelling the receiver account registration.

Although the payment is initiated by the payment sender in the two examples shown in FIGS. 3A-3B above, the system (100) of FIG. 1 and the method described with respect to FIG. 2 above may be used in other examples where the payment is initiated (or requested) by the payment recipient.

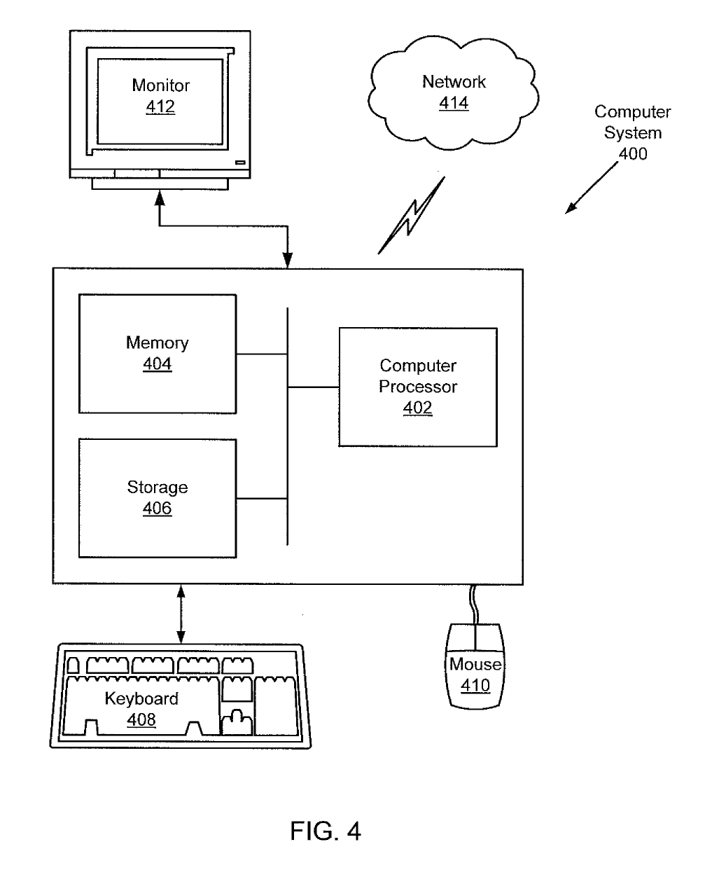

Embodiments of the invention may be implemented on virtually any type of computer regardless of the platform being used. For example, as shown in FIG. 4, a computer system (400) includes one or more computer processor(s) (402) such as a central processing unit (CPU), integrated circuit, or other hardware processor, associated memory (404) (e.g., random access memory (RAM), cache memory, flash memory, etc.), a storage device (406) (e.g., a hard disk, an optical drive such as a compact disk drive or digital video disk (DVD) drive, a flash memory stick, etc.), and numerous other elements and functionalities typical of today's computers (not shown). The computer system (400) may also include input means, such as a keyboard (408), a mouse (410), or a microphone (not shown). Further, the computer system (400) may include output means, such as a monitor ((412) (e.g., a liquid crystal display (LCD), a plasma display, or cathode ray tube (CRT) monitor). The computer system (400) may be connected to a network (414) (e.g., a local area network (LAN), a wide area network (WAN) such as the Internet, or any other similar type of network)) with wired and/or wireless segments via a network interface connection. Those skilled in the art will appreciate that many different types of computer systems exist, and the aforementioned input and output means may take other forms. Generally speaking, the computer system (400) includes at least the minimal processing, input, and/or output means necessary to practice embodiments of the invention.

Further, those skilled in the art will appreciate that one or more elements of the aforementioned computer system (400) may be located at a remote location and connected to the other elements over a network. Further, embodiments of the invention may be implemented on a distributed system having a plurality of nodes, where each portion of the invention may be located on a different node within the distributed system. In one embodiment of the invention, the node corresponds to a computer system. Alternatively, the node may correspond to a processor with associated physical memory. The node may alternatively correspond to a processor with shared memory and/or resources. Further, software instructions for performing embodiments of the invention may be stored on a non-transitory computer readable storage medium such as a compact disc (CD), a diskette, a tape, or any other computer readable storage device.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method to send a payment to satisfy an obligation, comprising:
receiving, by a payment service, a target time request to complete the payment, wherein the target time request comprises a first target time for completing at least a first portion of the payment;
comparing, in response to receiving the target time request, a current time and the first target time to determine a first available payment processing time;
selecting a first electronic funds transfer (EFT) network from a plurality of EFT networks based on matching the first available payment processing time to a first estimated payment processing time of the first EFT network; and
initiating, in response to selecting the first EFT network, processing of the first portion of the payment using the first EFT network.

2. The method of claim 1, further comprising:
comparing, in response to receiving the target time request, the current time and a second target time to determine a second available payment processing time, wherein the target time request further comprises the second target time for completing a second portion of the payment;
selecting a second EFT network from the plurality of EFT networks, wherein the second EFT network is selected based on matching the second available payment processing time to a second estimated payment processing time of the second EFT network; and
initiating, in response to selecting the second EFT network, processing of the second portion of the payment using the second EFT network,
wherein the payment is completed by at least processing the first portion and the second portion.

3. The method of claim 1, further comprising:
receiving, from a sender of the payment, a payment request to initiate the payment; and
sending, in response to the payment request, a payment notification to a recipient of the payment, and
wherein the target time request is specified by the sender in a user interface menu used by the sender to send the payment request.

4. The method of claim 1, further comprising:
receiving, from a sender of the payment, a payment request to initiate the payment; and
sending, in response to the payment request, a payment notification to a recipient of the payment, and
wherein the target time request is specified by the recipient in a user interface menu used by the recipient to display the payment notification.

5. The method of claim 1, further comprising:
receiving, from a recipient of the payment, a payment request to initiate the payment; and
sending, in response to the payment request, a payment notification to a sender of the payment, and
wherein the target time request is specified by the recipient in a user interface menu used by the recipient to send the payment request.

6. The method of claim 1, further comprising:
receiving, from a recipient of the payment, a payment request to initiate the payment; and
sending, in response to the payment request, a payment notification to a sender of the payment, and
wherein the target time request is specified by the sender in a user interface menu used by the sender to display the payment notification.

7. The method of claim 1, further comprising:
determining that the target time request is submitted by a sender of the payment; and
debiting a service fee from a financial account of the sender.

8. The method of claim 1, further comprising:
determining that the target time request is submitted by a recipient of the payment; and
deducting a service fee from a payment amount of the first portion.

9. The method of claim 2, further comprising:
determining that the target time request is submitted by a recipient of the payment;
deducting a first service fee from a first payment amount of the first portion; and
deducting a second service fee from a second payment amount of the second portion.

10. A system for sending a payment to satisfy an obligation, comprising:
a processor of a computer server operated by a payment service;
memory storing instructions when executed causing the processor to:
receive a target time request to complete the payment, wherein the target time request comprises a first target time for completing at least a first portion of the payment;
compare, in response to the target time request, a current time and the first target time to determine a first available payment processing time;
select a first electronic funds transfer (EFT) network from a plurality of EFT networks, wherein the first EFT network is selected based on matching the first available payment processing time to a first estimated payment processing time of the first EFT network; and
initiate, in response to selecting the first EFT network, processing of the first portion using the first EFT network; and
a repository coupled to the processor and configured to store the first estimated payment processing time.

11. The system of claim 10, wherein the instructions when executed further cause the processor to:
compare, in response to the target time request, the current time and a second target time to determine a second available payment processing time, wherein the target time request further comprises the second target time for completing a second portion of the payment;
select a second EFT network from the plurality of EFT networks, wherein the second EFT network is selected based on matching the second available payment processing time to a second estimated payment processing time of the second EFT network; and
initiate, in response to selecting the second EFT network, processing of the second portion using the second EFT network,
wherein the payment is completed by at least processing the first portion and the second portion.

12. The system of claim 10, wherein the instructions when executed further cause the processor to:
receive, from a sender of the payment, a payment request to initiate the payment; and
send, in response to the payment request, a payment notification to a recipient of the payment, and
wherein the target time request is specified by the sender in a user interface menu used by the sender to send the payment request.

13. The system of claim 10, wherein the instructions when executed further cause the processor to:
receive, from a sender of the payment, a payment request to initiate the payment; and
send, in response to the payment request, a payment notification to a recipient of the payment, and
wherein the target time request is specified by the recipient in a user interface menu used by the recipient to display the payment notification.

14. The system of claim 10, wherein the instructions when executed further cause the processor to:
receive, from a recipient of the payment, a payment request to initiate the payment; and
send, in response to the payment request, a payment notification to a sender of the payment, and
wherein the target time request is specified by the recipient in a user interface menu used by the recipient to send the payment request.

15. The system of claim 10, wherein the instructions when executed further cause the processor to:
receive, from a recipient of the payment, a payment request to initiate the payment; and
send, in response to the payment request, a payment notification to a sender of the payment, and
wherein the target time request is specified by the sender in a user interface menu used by the sender to display the payment notification.

16. The system of claim 10, wherein the instructions when executed further cause the processor to:
determine that the target time request is submitted by a sender of the payment; and
debit a service fee from a financial account of the sender.

17. The system of claim 10, wherein the instructions when executed further cause the processor to:
determine that the target time request is submitted by a recipient of the payment; and
deduct a service fee from a payment amount of the first portion.

18. The system of claim 10, wherein the instructions when executed further cause the processor to:
determine that the target time request is submitted by a recipient of the payment;
deduct a first service fee from a first payment amount of the first portion; and
deduct a second service fee from a second payment amount of the second portion.

19. A non-transitory computer readable medium storing instructions to send a payment to satisfy an obligation, the instructions comprising functionality to:
receive, by a payment service, a target time request to complete the payment, wherein the target time request comprises a first target time for completing at least a first portion of the payment;
compare, in response to receiving the target time request, a current time and the first target time to determine a first available payment processing time;
select a first electronic funds transfer (EFT) network from a plurality of EFT networks based on matching the first available payment processing time to a first estimated payment processing time of the first EFT network; and
initiate, in response to selecting the first EFT network, processing of the first portion of the payment using the first EFT network.

20. The non-transitory computer readable medium of claim 19, the instructions further comprising functionality to:
compare, in response to receiving the target time request, the current time and a second target time to determine a second available payment processing time, wherein the target time request further comprises the second target time for completing a second portion of the payment;
select a second EFT network from the plurality of EFT networks, wherein the second EFT network is selected based on matching the second available payment processing time to a second estimated payment processing time of the second EFT network; and
initiate, in response to selecting the second EFT network, processing of the second portion of the payment using the second EFT network,
wherein the payment is completed by at least processing the first portion and the second portion.

21. The non-transitory computer readable medium of claim 19, the instructions further comprising functionality to:
receive, from a sender of the payment, a payment request to initiate the payment; and
send, in response to the payment request, a payment notification to a recipient of the payment, and
wherein the target time request is specified by the sender in a user interface menu used by the sender to send the payment request.

22. The non-transitory computer readable medium of claim 19, the instructions further comprising functionality to:
receive, from a sender of the payment, a payment request to initiate the payment; and
send, in response to the payment request, a payment notification to a recipient of the payment, and
wherein the target time request is specified by the recipient in a user interface menu used by the recipient to display the payment notification.

23. The non-transitory computer readable medium of claim 19, the instructions further comprising functionality to:
receive, from a recipient of the payment, a payment request to initiate the payment; and
send, in response to the payment request, a payment notification to a sender of the payment, and
wherein the target time request is specified by the recipient in a user interface menu used by the recipient to send the payment request.

24. The non-transitory computer readable medium of claim 19, the instructions further comprising functionality to:
receive, from a recipient of the payment, a payment request to initiate the payment; and
send, in response to the payment request, a payment notification to a sender of the payment, and
wherein the target time request is specified by the sender in a user interface menu used by the sender to display the payment notification.

25. The non-transitory computer readable medium of claim 19, the instructions further comprising functionality to:
determine that the target time request is submitted by a sender of the payment; and
debit a service fee from a financial account of the sender.

26. The non-transitory computer readable medium of claim 19, the instructions further comprising functionality to:
determine that the target time request is submitted by a recipient of the payment; and
deduct a service fee from a payment amount of the first portion.

27. The non-transitory computer readable medium of claim. 20, the instructions further comprising functionality to:
determine that the target time request is submitted by a recipient of the payment;
deduct a first service fee from a first payment amount of the first portion; and
deduct a second service fee from a second payment amount of the second portion.
